(19) United States
(12) Patent Application Publication
(10) Pub. No.: US 2026/0006622 A1
(43) Pub. Date: Jan. 1, 2026

(54) Downlink Control Information Design for Supporting Single DCI Scheduling for Multiple Cells

(71) Applicant: Apple Inc., Cupertino, CA (US)

(72) Inventors: Haitong Sun, Cupertino, CA (US); Dawei Zhang, Saratoga, CA (US); Oghenekome Oteri, San Diego, CA (US); Hong He, Cupertino, CA (US); Wei Zeng, San Diego, CA (US); Yushu Zhang, Being (CN); Chunxuan Ye, San Diego, CA (US); Jie Cui, San Jose, CA (US)

(21) Appl. No.: 18/855,828

(22) PCT Filed: Apr. 28, 2022
(86) PCT No.: PCT/CN2022/089794

§ 371 Date: Oct. 10, 2024

(51) Int. Cl. H04W 72/232; H04B 7/06; H04L 27/26; H04W 52/14; H04W 72/0446; H04W 72/0453; H04W 72/1273

(52) U.S. Cl. CPC H04W 72/232; H04B 7/0626; H04L 27/2607; H04W 52/146; H04W 72/0446; H04W 72/0453; H04W 72/1273

(57) ABSTRACT

A single Data Control Information (DCI) may be used to schedule physical data channels, e.g., PDSCH/PUSCH, for a given device/user equipment (UE) on multiple cells. Accordingly, a single DCI may be transmitted to a device/UE to schedule physical data channels on multiple cells for the device/UE, for example to concurrently schedule the physical data channels for the device on multiple cells/component carriers. The single DCI may include multiple DCI fields for indicating required communication parameters. Each DCI field of at least a subset of the multiple DCI fields is either used for every cell of the multiple cells or for a corresponding single cell of the multiple cells. Whether a single DCI field or multiple DCI fields are used for a given relevant communication parameter may be determined individually for each of the relevant communication parameters which are to be indicated in the single DCI.

### PRIORITY INFORMATION

This application is a national stage entry of PCT Application No. PCT/CN2022/089794, entitled “Downlink Control Information Design for Supporting Single DCI Scheduling for Multiple Cells,” filed Apr. 28, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD OF THE INVENTION

The present application relates to wireless communications, including single downlink control information (DCI) scheduling for multiple cells.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), IEEE 802.16 (WiMAX), BLUETOOTH™, etc. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communication systems, including NR cellular wireless communications, is the use of physical control channels to provide physical data channel scheduling information to mobile devices. At least part of the scheduling information is provided vial downlink control information (DCI) transmitted over the physical control channel. At the present time, a single DCI can only be used to schedule a physical data channel on one (e.g., a single) cell. Improvements in the field are desired.

### SUMMARY OF THE INVENTION

Embodiments are presented herein of, inter alia, of methods and procedures for using a single downlink control information (DCI) to schedule physical data channel(s) on multiple cells or component carriers (CCs) for a UE during wireless communications, for example during 3GPP New Radio (NR) communications. Embodiments are further presented herein for wireless communication systems containing at least wireless communication devices or user equipment devices (UEs) and/or base stations and/or access points (APs) communicating with each other within the wireless communication systems.

In some embodiments, a method for scheduling physical data channels on multiple cells or component carriers may include transmitting, to a device, (e.g., a UE), single downlink control information (DCI) that schedules physical data channels, e.g., PDSCH or PUSCH, on multiple cells or component carriers for the device. In some embodiments, the single DCI may be used to concurrently schedule physical data channels for a device/UE on multiple cells/component carriers. The single DCI may include one or more DCI fields, where each DCI field of at least a subset of the DCI fields is either used for every cell of the multiple cells, or a corresponding single cell of the multiple cells. The DCI fields may include any one or more of a virtual resource block (VRB) to physical resource block (PRB) mapping field, a PRB bundling size indicator field, a rate matching indicator field, a zero power (ZP) channel state information reference signal (CSI-RS) trigger field, a hybrid automatic repeat request (HARQ) process number field, a transmit power control (TPC) command for scheduled physical uplink control channel (PUCCH) field, a PUCCH resource indicator field, a physical downlink shared channel (PDSCH)-to-HARQ feedback timing indicator field, a sounding reference signal (SRS) request field, a code block group (CBG) transmission information (CBGTI) field, a CBG flushing out information (CBGFI) field, a demodulation reference signal (DMRS) sequence initialization field, a priority indicator field, a minimum applicable scheduling offset indicator field, or a secondary cell (SCell) dormancy indication field.

In some embodiments, the single DCI may be defined based on a multi-carrier radio network temporary identifier defined to scramble a cyclic redundancy check (CRC) of the single DCI. The single DCI may have a special format such that each DCI field is designed to indicate scheduling of information for multiple scheduled cells, for example such that the DCI fields concurrently indicate scheduling of information for multiple scheduled cells. The single DCI may be the result of a concatenation of individual DCIs, each individual DCI corresponding to a different cell of the multiple cells.

The DCI fields may include multiple carrier indicator (CI) fields, with each CI field corresponding to a different single cell of the multiple cells, or they may include a single CI field that corresponds to every cell of the multiple cells. The mapping of the single CI field to the multiple cells may be configured by a serving base station serving the device, e.g., via station via radio resource control (RRC) signaling. In some embodiment the mapping may be updated via a media access control (MAC) control element (CE). In some embodiments, the mapping of the single CI field to the multiple cells may be predetermined for each scheduled cell of the multiple cells, e.g., it may be hard coded in the 3GPP standard.

The DCI fields may include multiple bandwidth part (BWP) indicator (BWPI) fields where each BWPI field corresponds to a different single cell of the multiple cells, or they may include a single BWPI field that corresponds to every cell of the multiple cells. The device may switch to a BWP indicated by the BWPI field on every cell of the multiple cells, or it may switch to a BWP indicated by the BWPI field on only a single cell. The single BWPI field may be mapped to multiple BWPs with the mapping between the BWPI field and a BWP in each cell of the multiple cells either predetermined or configured by a serving base station, e.g., via RRC signaling.

The same frequency domain resource allocation (FDRA) type may be configured for every cell of the multiple cells, or a different FDRA type may be configured for each cell of the multiple cells. Accordingly, the DCI fields may include multiple FDRA fields where each FDRA field corresponds to a different single cell of the multiple cells, or they may include a single FDRA field that corresponds to every cell of the multiple cells. In some embodiments, the size of a first active BWP indicated by the FDRA field for a first cell of the multiple cells may differ from the size of a second active BWP indicated by the FDRA field for a second cell of the multiple cells. In some embodiments, when indicating the FDRA in the second BWP requires fewer bits than indicating the FDRA in the first BWP, one or more most significant bits of the FDRA field may be discarded. Similarly, when indicating the FBRA in the second BWP requires more bits than indicating the FDRA in the first BWP, one or more zero bits may be appended to the most significant bit.

The DCI fields may include multiple time domain resource allocation (TDRA) fields wherein each TDRA field corresponds to a different single cell of the multiple cells, or they may include a single TDRA field that corresponds to every cell of the multiple cells. The single TDRA field may indicate the same TDRA for every cell of the multiple cells, or it may indicate a first TDRA for a first cell of the multiple cells, and a second TDRA for a second cell of the multiple cells may be derived from the first TDRA. Derivation of the second TDRA from the first TDRA may be configured via RRC, e.g., via RRC signaling by a serving base station. In some embodiments, the second TDRA may be derived via an offset of starting symbols, and the mapping types and/or the duration of the scheduled physical data channel may be the same for every cell of the multiple cells. In some embodiments, corresponding TDRA value for each cell may be obtained from a TDRA table indexed by a value indicated in the single TDRA field.

The DCI fields may include multiple transmission configuration indication (TCI) fields where each TCI field corresponds to a different single cell of the multiple cells, or they may include a single TCI field that corresponds to every cell of the multiple cells. For every cell of the multiple cells, the device may use the TCI State index indicated by the TCI field or a quasi-co-location (QCL) source configured in a TCI state indicated by the TCI State index in the TCI field for a given cell of the multiple cells. The given cell may be determined according to a specified attribute of the given cell, e.g., specified in the 3GPP specification as the scheduled cell with the smallest cell ID, or it may be determined according to an indication received by the device from a serving base station, e.g., via RRC/MAC-CE/DCI signaling. A corresponding TCI state for each cell of the multiple cells may be obtained from a TCI table indexed by the value indicated in the single TCI field. In some embodiments, the device may use a default beam for each cell of the multiple cells when an offset between the single DCI and a corresponding scheduled physical data channel is smaller than a specified threshold value. The default beam may be defined by the TCI state of a control resource set (CORESET) with a lowest identifier (ID) in a last DCI monitoring slot, the TCI State of a CORESET with a lowest ID, or an active TCI of the corresponding scheduled physical data channel on each cell with the lowest ID. When the device cannot simultaneously receive on multiple beams configured for the device, the device may use a beam scheduled for the cell with the lowest identifier, or it may use a beam determined by the device itself (e.g., the device may be implemented to determine which beam to use in such a scenario.

The DCI fields may include multiple antenna ports (AP) fields where each AP field corresponds to a different single cell of the multiple cells, or they may include an AP field that corresponds to every cell of the multiple cells. When using a single AP field, the device may be scheduled with the same port configuration on every cell of the multiple cells. When the number of bits used to indicate the AP for one scheduled physical data channel differs from the number of bits used to indicate the AP for another scheduled physical data channel, one or more most significant bits in the AP field may be either padded or truncated. The single AP field may indicate a single AP configuration, and a different code division multiplexing group may be used for mapping to each different cell of the multiple cells.

The DCI fields may include multiple coding and modulation scheme/new data indicator/redundancy version (MCS/NDI/RV) fields where each MCS/NDI/RV field corresponds to a different single cell of the multiple cells, or they may include a single MCS/NDI/RV field that corresponds to every cell of the multiple cells. When a single MCS/NDI/RV field is used, the device may be scheduled with the same transport block (TB) configuration on every cell of the multiple cells. In some embodiments, the MCS/NDI/RV for a first codeword may correspond to a scheduled first physical data channel on a first cell of the multiple cells, and the MCS/NDI/RV for a second codeword may correspond to a scheduled second physical data channel on a second cell of the multiple cells.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 shows an exemplary simplified block diagram illustrative of cellular communication circuitry, according to some embodiments;

FIG. 6 shows an exemplary table of DCI fields and the corresponding communication parameters for which they provide an indication/information;

FIG. 7 shows an exemplary table that includes a carrier indicator field in DCI for use of a single DCI for scheduling physical data channels on multiple cells/component carriers, according to some embodiments;

FIG. 8 shows an exemplary table that includes a bandwidth part indicator field in DCI for use of a single DCI for scheduling physical data channels on multiple cells/component carriers, according to some embodiments; and

FIG. 9 shows an exemplary diagram illustrating an offset-based time domain resource assignment DCI format for use of a single DCI for scheduling physical data channels on multiple cells/component carriers, according to some embodiments;

FIG. 10 shows an exemplary table that includes a time domain resource assignment field in DCI for use of a single DCI for scheduling physical data channels on multiple cells/component carriers, according to some embodiments;

FIG. 11 shows an exemplary table that includes a transmission configuration indication field in DCI for use of a single DCI for scheduling physical data channels on multiple cells/component carriers, according to some embodiments; and

FIG. 12 shows an exemplary flow diagram illustrating a method of scheduling physical data channels on multiple cells, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
5GMM: 5G Mobility Management
AF: Application Function
AMF: Access and Mobility Management Function
AMR: Adaptive Multi-Rate
AP: Access Point
APN: Access Point Name
APR: Applications Processor
BS: Base Station
BSSID: Basic Service Set Identifier
CBG: Code Block Group
CBRS: Citizens Broadband Radio Service
CBSD: Citizens Broadband Radio Service Device
CCA: Clear Channel Assessment
CMR: Change Mode Request
CORESET: Control Resource Set
CS: Circuit Switched
CSI: Channel State Information
DCI: Downlink Control Information
DL: Downlink (from BS to UE)
DMRS: Demodulation Reference Signal
DN: Data Network
DSDS: Dual SIM Dual Standby
DYN: Dynamic
EDCF: Enhanced Distributed Coordination Function
eSNPN: Equivalent Standalone Non-Public Network
ETSI: European Telecommunications Standards Institute
FDD: Frequency Division Duplexing
FT: Frame Type
GAA: General Authorized Access
GPRS: General Packet Radio Service
GSM: Global System for Mobile Communication
GTP: GPRS Tunneling Protocol.
HPLMN: Home Public Land Mobile Network
IC: In Coverage
IMS: Internet Protocol Multimedia Subsystem
IOT: Internet of Things
IP: Internet Protocol
ITS: Intelligent Transportation Systems
LAN: Local Area Network
LBT: Listen Before Talk
LCS: Location Services
LMF: Location Management Function.
LPP: LTE Positioning Protocol
LQM: Link Quality Metric
LTE: Long Term Evolution
MCC: Mobile Country Code
MCS: Modulation and Coding Scheme
MNO: Mobile Network Operator
MO-LR: Mobile Originated Location Request
MT-LR: Mobile-Terminated Location Request
NAS: Non-Access Stratum
NDI: New Data Indicator
NF: Network Function.
NG-RAN: Next Generation Radio Access Network
NID: Network Identifier
NMF: Network Identifier Management Function
NPN: Non-Public (cellular) Network
NRF: Network Repository Function
NSI: Network Slice Instance
NSSAI: Network Slice Selection Assistance Information
OOC: Out Of Coverage.
PAL: Priority Access Licensee
PDCP: Packet Data Convergence Protocol
PDN: Packet Data Network
PDU: Protocol Data Unit
PGW: PDN Gateway.
PLMN: Public Land Mobile Network
ProSe: Proximity Services
PRS: Positioning Reference Signal
PSCCH: Physical Sidelink Control Channel
PSFCH: Physical Sidelink Feedback Channel
PSSCH: Physical Sidelink Shared Channel
PSD: Power Spectral Density
PSS: Primary Synchronization Signal.
PT: Payload Type
PTRS: Phase Tracking Reference Signal
PUCCH: Physical Uplink Control Channel
QBSS: Quality of Service Enhanced Basic Service Set
QI: Quality Indicator
RA: Registration Accept
RAT: Radio Access Technology
RF: Radio Frequency
RNTI: Radio Network Temporary Identifier.
ROHC: Robust Header Compression
RR: Registration Request
RRC: Radio Resource Control
RS: Reference Signal
RSRP: Reference Signal Receive Power
RTP: Real-time Transport Protocol
RV: Redundancy Version
RX: Reception/Receive
SAS: Spectrum Allocation Server
SD: Slice Descriptor
SI: System Information
SIB: System Information Block
SID: System Identification Number
SIM: Subscriber Identity Module
SGW: Serving Gateway
SMF: Session Management Function
SNPN: Standalone Non-Public Network
SRS: Sounding Reference Signal
SSS: Secondary Synchronization Signal
SUPI: Subscription Permanent Identifier
TBS: Transport Block Size
TCP: Transmission Control Protocol
TDD: Time Division Duplexing
TDRA: Time Domain Resource Allocation
TPC: Transmit Power Control
TX: Transmission/Transmit
UAC: Unified Access Control
UDM: Unified Data Management
UDR: User Data Repository
UE: User Equipment
UI: User Input
UL: Uplink (from UE to BS)
UMTS: Universal Mobile Telecommunication System
UPF: User Plane Function
URM: Universal Resources Management
URSP: UE Route Selection Policy
USIM: User Subscriber Identity Module
Wi-Fi: Wireless Local Area Network (WLAN) RAT based on the Institute of Electrical and Electronics Engineers' (IEEE) 802.11 standards
WLAN: Wireless LAN
ZP: Zero Power

### Terms

The Following is a Glossary of Terms that May Appear in the Present Application:
Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.
User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony PlayStation™, Microsoft XBox™, etc.), portable gaming devices (e.g., Nintendo DS™, PlayStation Portable™, Gameboy Advance™, iPod™), laptops, wearable devices (e.g. smart watch, smart glasses), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.
Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. 5G NR, LTE, CDMA, GSM), such as a base station or a cellular telephone, for example.
Communication Device—any of various types of computer systems or devices that perform communications, where the communications can be wired or wireless./communication device can be portable (or mobile) or may be stationary or fixed at a certain location. A wireless device is an example of a communication device. A UE is another example of a communication device.
Base Station (BS)—The term “Base Station” has the full breadth of its ordinary meaning, and at least includes a wireless communication station installed at a fixed location and used to communicate as part of a wireless telephone system or radio system.
Processor—refers to various elements (e.g. circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.
Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation. For example, in 5G NR, the operating frequency bands are categorized in two groups. More specifically, per 3GPP Release 15, frequency bands are designated for different frequency ranges (FR) and are defined as FR1 and FR2, with FR1 encompassing the 410 MHz-7125 MHz range and FR2 encompassing the 24250 MHz-52600 MHz range.
Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.
Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.
Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.
Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g. 10 ms). A radio frame in 3GPP LTE may be further divided into a specified number of (e.g. ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.
Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.
Bandwidth Part (BWP)—A carrier bandwidth part (BWP) is a contiguous set of physical resource blocks selected from a contiguous subset of the common resource blocks for a given numerology on a given carrier. For downlink, a UE may be configured with up to a specified number of carrier BWPs (e.g. four BWPs, per some specifications), with one BWP per carrier active at a given time (per some specifications). For uplink, the UE may similarly be configured with up to several (e.g. four) carrier BWPs, with one BWP per carrier active at a given time (per some specifications). If a UE is configured with a supplementary uplink, then the UE may be additionally configured with up to the specified number (e.g. four) carrier BWPs in the supplementary uplink, with one carrier BWP active at a given time (per some specifications).
Multi-cell Arrangements—A Master node is defined as a node (radio access node) that provides control plane connection to the core network in case of multi radio dual connectivity (MR-DC). A master node may be a master eNB (3GPP LTE) or a master gNB (3GPP NR), for example. A secondary node is defined as a radio access node with no control plane connection to the core network, providing additional resources to the UE in case of MR-DC. A Master Cell group (MCG) is defined as a group of serving cells associated with the Master Node, including the primary cell (PCell) and optionally one or more secondary cells (SCell). A Secondary Cell group (SCG) is defined as a group of serving cells associated with the Secondary Node, including a special cell, namely a primary cell of the SCG (PSCell), and optionally including one or more SCells. A UE may typically apply radio link monitoring to the PCell. If the UE is configured with an SCG then the UE may also apply radio link monitoring to the PSCell. Radio link monitoring is generally applied to the active BWPs and the UE is not required to monitor inactive BWPs. The PCell is used to initiate initial access, and the UE may communicate with the PCell and the SCell via Carrier Aggregation (CA). Currently Amended capability means a UE may receive and/or transmit to and/or from multiple cells. The UE initially connects to the PCell, and one or more SCells may be configured for the UE once the UE is in a connected state.
Core Network (CN)—Core network is defined as a part of a 3GPP system which is independent of the connection technology (e.g. the Radio Access Technology, RAT) of the UEs. The UEs may connect to the core network via a radio access network, RAN, which may be RAT-specific.
Downlink Control Information (DCI)—In 3GPP communications, DCI is transmitted to a mobile device or UE (e.g., by a serving base station in the network) and contains multiple different fields. Each field is used to configure one part or aspect of a scheduled communication(s) of the device. To put it another way, each field in the DCI may correspond to a specific communication parameter or parameters configuring a corresponding aspect of the scheduled communication(s) of the device. By decoding the DCI, the UE obtains all the configuring parameters or parameter values according to the fields in the DCI, thereby obtaining all the information about the scheduled communication(s) and subsequently performing the scheduled communication(s) according to those parameters/parameter values.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

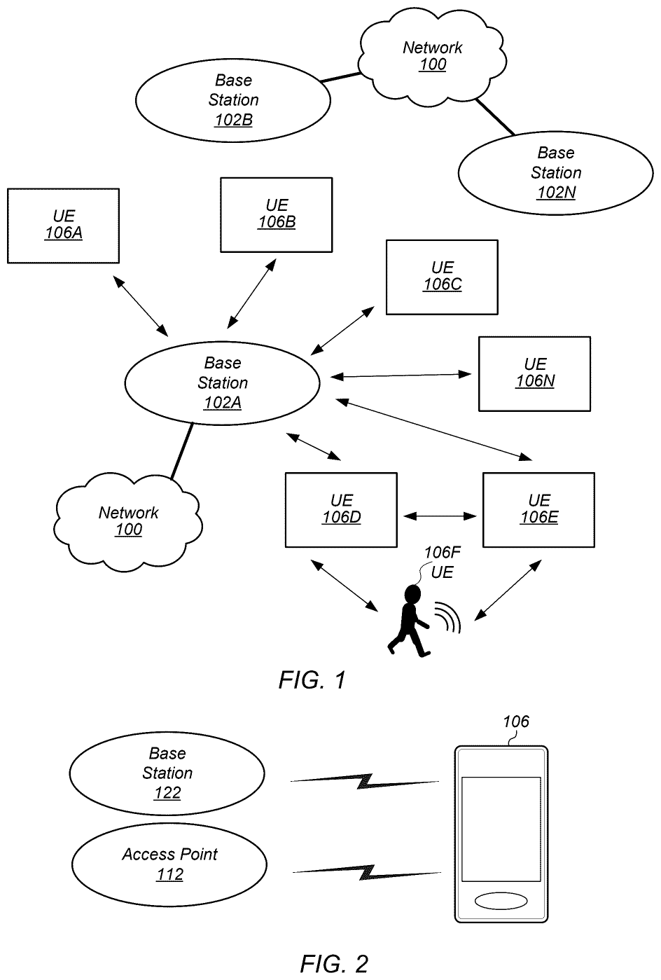

### FIGS. 1 and 2—Exemplary Communication Systems

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes base stations 102A through 102N, also collectively referred to as base station(s) 102 or base station 102. As shown in FIG. 1, base station 102A communicates over a transmission medium with one or more user devices 106A through 106N. Each of the user devices may be referred to herein as a “user equipment” (UE) or UE device. Thus, the user devices 106A through 106N are referred to as UEs or UE devices, and are also collectively referred to as UE(s) 106 or UE 106.

The base station 102A may be a base transceiver station (BTS) or cell site, and may include hardware that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, neutral host or various CBRS (Citizens Broadband Radio Service) deployments, among various possibilities). Thus, the base station 102A may facilitate communication between the user devices 106 and/or between the user devices 106 and the network 100. In particular, the cellular base station 102A may provide UEs 106 with various telecommunication capabilities, such as voice, short message service (SMS) and/or data services. The communication area (or coverage area) of the base station 106 may be referred to as a “cell.” It is noted that “cell” may also refer to a logical identity for a given wireless communication coverage area at a given frequency. In general, any independent cellular wireless coverage area may be referred to as a “cell”. In such cases a base station may be situated at particular confluences of three cells. The base station, in this uniform topology, may serve three 120 degree beam width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g. remote radio heads). As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network, and may further also be considered at least a part of the UE communicating on the network or over the network.

The base station(s) 102 and the user devices 106 may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G-NR (NR, for short), 3GPP2 CDMA2000 (e.g., 1×RTT, 1×EV-DO, HRPD, eHRPD), Wi-Fi, WiMAX etc. Note that if the base station 102A is implemented in the context of LTE, it may alternately be referred to as an ‘eNodeB’ or ‘eNB’. Similarly, if the base station 102A is implemented in the context of 5G NR, it may alternately be referred to as ‘gNodeB’ or ‘gNB’. In some embodiments, the base station 102 (e.g. an eNB in an LTE network or a gNB in an NR network) may communicate with at least one UE having the capability to transmit reference signals according to various embodiments disclosed herein. Depending on a given application or specific considerations, for convenience some of the various different RATs may be functionally grouped according to an overall defining characteristic. For example, all cellular RATs may be collectively considered as representative of a first (form/type of) RAT, while Wi-Fi communications may be considered as representative of a second RAT. In other cases, individual cellular RATs may be considered individually as different RATs. For example, when differentiating between cellular communications and Wi-Fi communications, “first RAT” may collectively refer to all cellular RATs under consideration, while “second RAT” may refer to Wi-Fi. Similarly, when applicable, different forms of Wi-Fi communications (e.g. over 2.4 GHz vs. over 5 GHz) may be considered as corresponding to different RATs. Furthermore, cellular communications performed according to a given RAT (e.g. LTE or NR) may be differentiated from each other on the basis of the frequency spectrum in which those communications are conducted. For example, LTE or NR communications may be performed over a primary licensed spectrum as well as over a secondary spectrum such as an unlicensed spectrum and/or spectrum that was assigned to private networks. Overall, the use of various terms and expressions will always be clearly indicated with respect to and within the context of the various applications/embodiments under consideration.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices 106 and/or between the user devices 106 and the network 100. In particular, the cellular base station 102A may provide UEs 106 with various telecommunication capabilities, such as voice, SMS and/or data services. UE 106 may be capable of communicating using multiple wireless communication standards. For example, a UE 106 might be configured to communicate using any or all of a 3GPP cellular communication standard (such as LTE or NR) or a 3GPP2 cellular communication standard (such as a cellular communication standard in the CDMA2000 family of cellular communication standards). Base station 102A and other similar base stations (such as base stations 102B . . . 102N) operating according to the same or a different cellular communication standard may thus be provided as one or more networks of cells, which may provide continuous or nearly continuous overlapping service to UE 106 and similar devices over a wide geographic area via one or more cellular communication standards.

Thus, while base station 102A may act as a “serving cell” for UEs 106A-106N as illustrated in FIG. 1, each one of UE(s) 106 may also be capable of receiving signals from (and may possibly be within communication range of) one or more other cells (possibly provided by base stations 102B-102N and/or any other base stations), which may be referred to as “neighboring cells”. Such cells may also be capable of facilitating communication in-between user devices 106 and/or between user devices 106 and the network 100. Such cells may include “macro” cells, “micro” cells, “pico” cells, and/or cells which provide any of various other granularities of service area size. For example, base stations 102A-102B illustrated in FIG. 1 may be macro cells, while base station 102N may be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

The UE 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible. Furthermore, the UE 106 may also communicate with Network 100, through one or more base stations or through other devices, stations, or any appliances not explicitly shown but considered to be part of Network 100. UE 106 communicating with a network may therefore be interpreted as the UE(s) 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

As also illustrated in FIG. 1, at least some of the UEs, e.g. UEs 106D and 106E may represent vehicles communicating with each other and with base station 102, e.g. via cellular communications such as 3GPP LTE and/or 5G-NR communications, for example. In addition, UE 106F may represent a pedestrian who is communicating and/or interacting in a similar manner with the vehicles represented by UEs 106D and 106E. Various embodiments of vehicles communicating in a network exemplified in FIG. 1 are disclosed, for example, in the context of vehicle-to-everything (V2X) communications such as the communications specified by certain versions of the 3GPP standard, among others.

FIG. 2 illustrates an exemplary user equipment 106 (e.g., one of UEs 106A through 106N) in communication with the base station 122 and an access point 112, according to some embodiments. The UE 106 may be a device with both cellular communication capability and non-cellular communication capability (e.g., BLUETOOTH™, Wi-Fi, and so forth) such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, NR, WLAN, or GNSS. Other combinations of wireless communication standards are also possible.

The UE 106 may include one or more antennas for communicating using one or more wireless communication protocols according to one or more RAT standards, e.g. those previously mentioned above. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios or radio circuitry which are shared between multiple wireless communication protocols, and one or more radios which are used exclusively by a single wireless communication protocol. For example, the UE 106 may include radio circuitries for communicating using either of LTE or CDMA2000 1×RTT or NR, and separate radios for communicating using each of Wi-Fi and BLUETOOTH™. Other configurations are also possible.

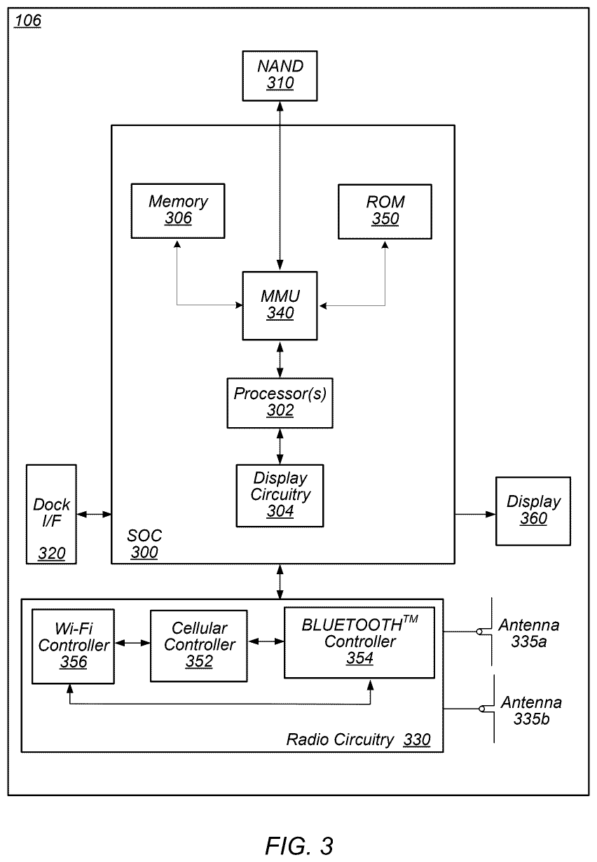

### FIG. 3—Block Diagram of an Exemplary UE

FIG. 3 illustrates a block diagram of an exemplary UE 106, according to some embodiments. As shown, the UE 106 may include a system on chip (SOC) 300, which may include various elements/components for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station 102) may include hardware and software components for implementing methods for at least UE 106 to transmit reference signals according to various embodiments disclosed herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to implement communications by UE 106 to transmit reference signals according to various embodiments disclosed herein. Specifically, processor(s) 302 may be coupled to and/or may interoperate with other components as shown in FIG. 3 to facilitate UE 106 communicating in a manner that seeks to optimize RAT selection. Processor(s) 302 may also implement various other applications and/or end-user applications running on UE 106.

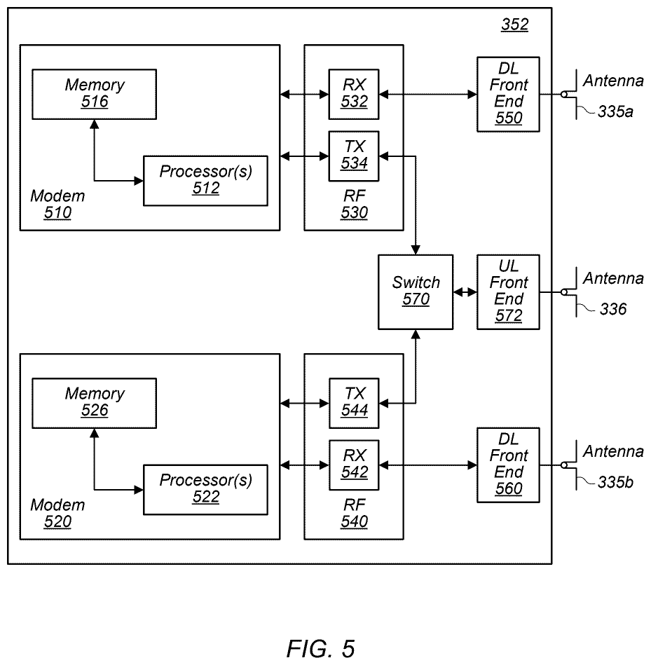

In some embodiments, radio circuitry 330 may include separate controllers dedicated to controlling communications for various respective RATs and/or RAT standards. For example, as shown in FIG. 3, radio circuitry 330 may include a Wi-Fi controller 356, a cellular controller (e.g. LTE and/or NR controller) 352, and BLUETOOTH™ controller 354, and according to at least some embodiments, one or more or all of these controllers may be implemented as respective integrated circuits (ICs or chips, for short) in communication with each other and with SOC 300 (e.g. with processor(s) 302). For example, Wi-Fi controller 356 may communicate with cellular controller 352 over a cell-ISM link or WCI interface, and/or BLUETOOTH™ controller 354 may communicate with cellular controller 352 over a cell-ISM link, etc. While three separate controllers are illustrated within radio circuitry 330, other embodiments may have fewer or more similar controllers for various different RATs and/or RAT standards that may be implemented in UE device 106. For example, at least one exemplary block diagram illustrative of some embodiments of cellular controller 352 is shown in FIG. 5 and will be further described below.

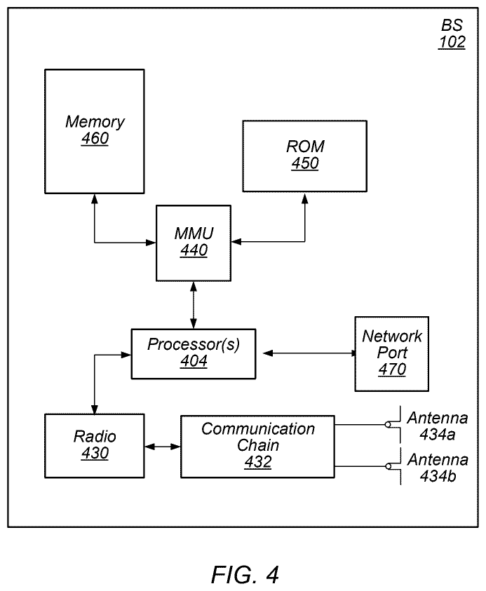

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434a, and possibly multiple antennas (e.g. illustrated by antennas 434a and 434b), for performing wireless communication with mobile devices and/or other devices. Antennas 434a and 434b are shown by way of example, and base station 102 may include fewer or more antennas. Overall, the one or more antennas, which may include antenna 434a and/or antenna 434b, are collectively referred to as antenna 434 or antenna(s) 434. Antenna(s) 434 may be configured to operate as a wireless transceiver and may be further configured to communicate with UE devices 106 via radio circuitry 430. The antenna(s) 434 communicates with the radio 430 via communication chain 432. Communication chain 432 may be a receive chain, a transmit chain or both. The radio circuitry 430 may be designed to communicate via various wireless telecommunication standards, including, but not limited to, LTE, LTE-A, 5G-NR (NR) WCDMA, CDMA2000, etc. The processor(s) 404 of the base station 102 may be configured to implement part or all of the methods described herein, e.g., by executing program instructions stored on a memory medium (e.g., a non-transitory computer-readable memory medium). Alternatively, the processor(s) 404 may be configured as a programmable hardware element(s), such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g. it may include at least one Ethernet port, and radio 430 may be designed to communicate according to the Wi-Fi standard.

### FIG. 5—Exemplary Cellular Communication Circuitry

FIG. 5 illustrates an exemplary simplified block diagram illustrative of cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 352 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 may couple (e.g., communicatively; directly or indirectly) to one or more antennas, such as antennas 335a-b and 336 as shown. In some embodiments, cellular communication circuitry 352 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 352 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more components. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 352 may include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 may be in communication, e.g., directly, with the UL front end 572.

### Physical Data Channel Scheduling

In the present 3GPP NR standard, including Rel-15/16/17, a single DCI can only be used to schedule a physical data channel, e.g., PDSCH, on one cell, or in other words on a single cell or component carrier. The scheduled cell is indicated by the “Carrier Indicator” field in the DCI. Mapping of the “Carrier Indicator” field value to the actual cell is configured by radio resource control (RRC) and is per scheduled cell. As part of implementing multi-carrier enhancements, agreement was reached to support the enhancement of using a single downlink control information (DCI) to schedule physical data channels, e.g., PDSCH/PUSCH, on multiple cells for a device. Solutions for such single-DCI scheduling of physical data channel(s) on multiple cells are expected to account for:
Identifying the maximum number of cells that can be concurrently scheduled;
Considering both intra-band and inter-band carrier aggregation (CA) operation;
Considering both frequency range 1 (FR1) and frequency range 2 (FR2); and
Optimizing the single DCI for three or more cells for multi-cell PUSCH/PDSCH scheduling.

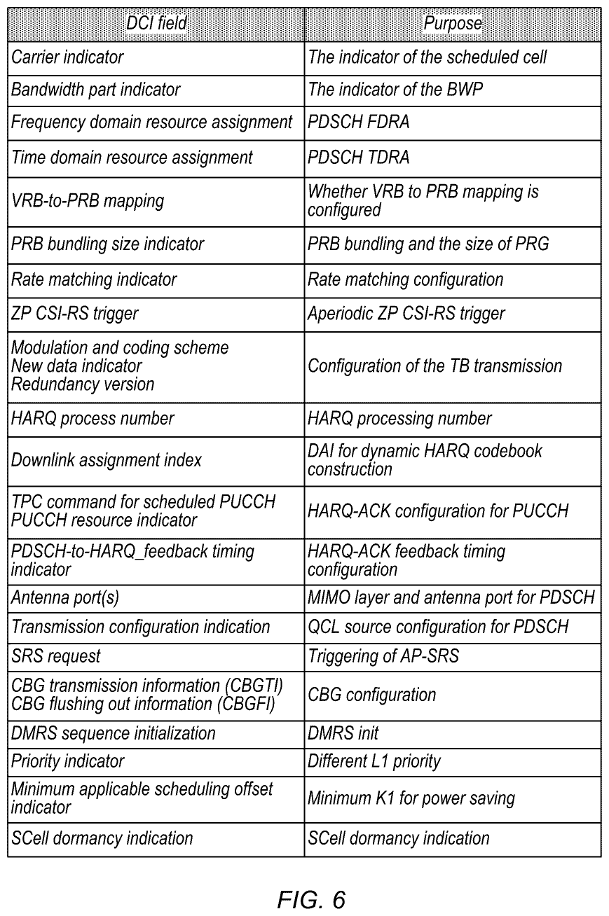

The motivation of single DCI to schedule multiple cells is to reduce the PDCCH overhead, e.g., reducing the DCI size. However, except for a few DCI fields such as CRC (Cyclic Redundancy Check), use of a single DCI for scheduling (e.g., physical data channels) on multiple cells leads to a trade-off between scheduling flexibility and DCI size reduction. In order to assess the issue, consideration needs to be given to at least the DL DCI fields shown in the table of FIG. 6. The various DCI fields shown in the table of FIG. 6 each correspond to a respective communication parameter or operating parameter related to scheduling communications, e.g., physical data channel communications, for a given device (UE) on a cell, or in this case on multiple cells.

In various embodiments, design choices for single DCI scheduling PDSCH (communications) on multiple cells may include specific consideration for:
Carrier Indicator
Bandwidth part (BWP) indicator;
Frequency Domain Resource Assignment (FDRA);
Time Domain Resource Assignment (TDRA);
Transmission Configuration Indication (TCI);
Antenna port(s); and
Modulation and Coding Scheme (MCS), New Data Indicator (NDI), Redundancy Version (RV) indication.

### DCI Format Indication

According to a first proposal, a new DCI may be defined based on a new Radio Network Temporary Identifier (RNTI). A new RNTI, e.g., MC (multi-carrier)-RNTI may be defined to scramble the CRC of the DCI that schedules multiple cells concurrently.

According to a second proposal, a new DCI format may be defined for scheduling physical data channels for a device on multiple cells via a single DCI. For example, a new “DCI format 1_3” may be established. Each DCI field in the new DCI according to this new format may be designed to indicate the scheduling of information for multiple scheduled cells, for example to concurrently indicate the scheduling of information for multiple scheduled cells.

According to a third proposal, an existing DCI format may be used, and concatenation of the existing DCI format, e.g., “DCI format 1_2” or “DCI format 1_1” may be used for forming the new DCI. When multiple cells are scheduled by a single DCI, a corresponding DCI field size may be configured independently for each scheduled cell. Individual DCIs (each using an existing DCI format) corresponding to different cells may then be concatenated or combined to form the final DCI.

### Carrier Indicator

According to a first proposal, multiple “carrier indicator” fields may be included in the DCI format. Each “carrier indicator” may correspond to a different scheduled cell.

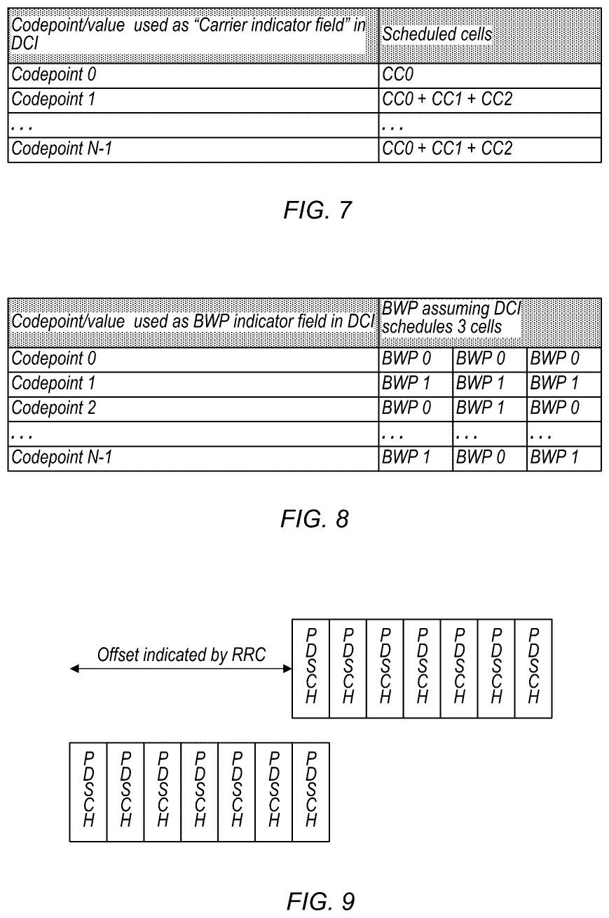

According to a second proposal, a single “carrier indicator” field may be used to map to multiple scheduled cells. The network (e.g., via a serving base station) may configure the mapping of the “carrier indicator” field to the list of scheduled cells. The network configuration may be based on RRC. Potentially, the mapping configured by the network may be changed via a MAC-CE. The mapping may also be predetermined, e.g., hardcoded in the specification (e.g., the 3GPP specification) for each specific number ‘N’ of scheduled cells, where N>=1. An exemplary configuration is illustrated in the table of FIG. 7.

### BWP Indicator

According to a first proposal, multiple “BWP Indicators” may be included in DCI format, with each “BWP indicator” corresponding to a different scheduled cell.

According to a second proposal, a single “BWP indicator” may be included in the DCI format. In a first option, the UE may switch to the BWP indicated by the “BWP Indicator” field for all the scheduled cells (in other words, for every scheduled cell). In a second option, the UE may switch to the BWP indicated by “BWP Indicator” field on only one of the scheduled (e.g., RRC configured) cells.

According to a third proposal, a single “BWP indicator” may be mapped to multiple BWPs. The mapping between the “BWP indicator” and the BWP in each scheduled cell may be either RRC configured or predetermined, e.g., hardcoded in the specification, e.g., in the 3GPP specification. One exemplary configuration is illustrated in the table of FIG. 8.

### FDRA (Frequency Domain Resource Assignment)

According to a first proposal, at least two options may be available for all the cells that are scheduled by a single DCI. In a first option, all the cells may be configured with the same resource allocation type, e.g., one of resource Allocation ENUMERATED {resource Allocation Type0, resource AllocationType1, dynamicSwitch}. In a second option, a different resource allocation type may be configured for each cell.

According to a second proposal, multiple “Frequency Domain Resource Assignment” DCI fields may be included in the DCI format, with each “Frequency Domain Resource Assignment” DCI field corresponding to a different scheduled cell.

According to a third proposal, a single “Frequency Domain Resource Assignment” DCI field may be included in the DCI format. The UE may be scheduled with the same FDRA for the PDSCH in each scheduled cell. In this case, DCI size alignment, e.g., when the size of active BWPs of different component carriers (CCs) are different, may be considered. In other words, the size of active BWPs of one CC or cell may differ from the size of active BWPs of a second CC or cell, and this may be taken into account in how the FDRA DCI field is implemented. If the second CC or cell requires fewer bits in terms of indicating the FDRA for the second CC or cell via the single FDRA DCI field, truncation may be applied, e.g., the most significant bit (MSB) may be discarded. If the second CC or cell requires a higher number of bits in terms of FDRA indication, an additional bit may be appended, for example a zero may be appended to the MSB.

### TDRA (Time Domain Resource Assignment)

According to a first proposal multiple “Time Domain Resource Assignment” DCI fields may be included in the DCI format, with each “Time Domain Resource Assignment” DCI Field corresponding to a different scheduled cell.

According to a second proposal, a single “Time Domain Resource Assignment” DCI field may be configured/included in the DCI format, and the UE may be scheduled with the same TDRA for PDSCH in all scheduled CCs. In this case the single TDRA DCI field (or TDRA field) may correspond to every scheduled cell.

According to a third proposal, when a single TDRA field is used, a second TDRA may be derived from a first TDRA (e.g., in case of two cells/CCs) as configured via RRC. For example, the second TDRA may be derived via the offset of the starting symbols. In other words, the second TDRA may be derived from the difference between the starting symbol of the PDSCH scheduled on the first CC or cell and the starting symbol of the PDSCH scheduled on the second CC or cell (e.g., something in-between 5.1 and 5.2). Accordingly, the following may be the same among all the scheduled CCs, e.g., all the concurrently scheduled CCs:
Mapping types, e.g., mappingType ENUMERATED {typeA, typeB}; and
The duration of the PDSCH, e.g., the number of symbols.
   This concept is illustrated in the exemplary diagram in FIG. 9.

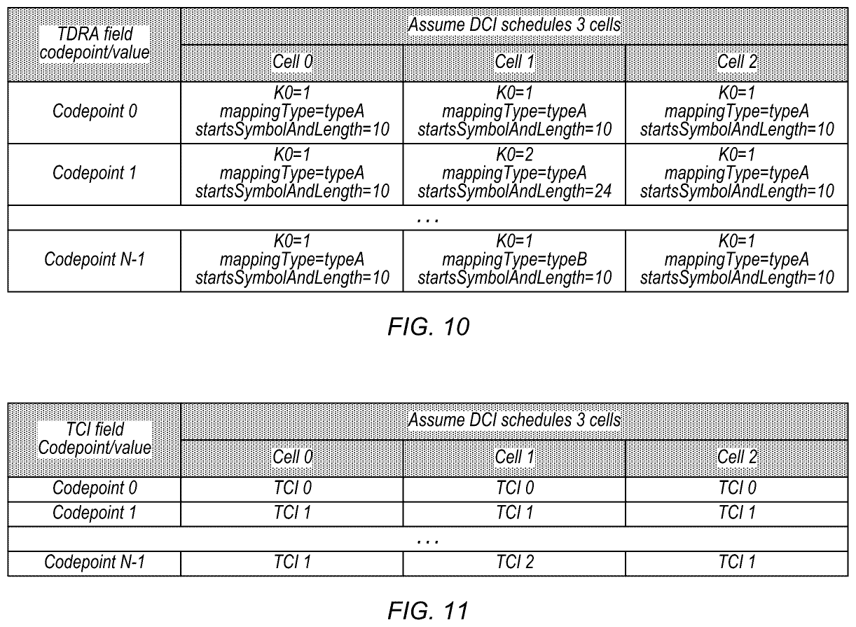

According to a fourth proposal, a single TDRA DCI field may correspond to every scheduled cell, and the network may configure a TDRA table. In the TDRA table, for each “Time Domain Resource Assignment” codepoint or value of the TDRA DCI field, there may be a corresponding TDRA for each scheduled cell according to the table, for example as illustrated in the table of FIG. 10 for a single DCI scheduling three (3) cells. An exemplary code segment for configuring the TDRA table may be:

PDSCH-TimeDomainResourceAllocationList ::= SEQUENCE (SIZE (1..maxNrofDL-Allocations ))
OF PDSCH-TimeDomainResourceAllocation
PDSCH- TimeDomainResourceAllocation ::= SEQUENCE {

| | | |
|---|---|---|
| K0 | INTEGER (0..32) | OPTIONAL, -- Need S |
| mappingType | ENUMERATED {typeA, typeB), | |
| startSymbolAndLength | INTEGER (0 .. 127) | |

}

### TCI (Transmission Configuration Indication)

According to a first proposal, multiple TCI DCI fields may be included in the DCI format, with each TCI field corresponding to a different scheduled cell.

According to a second proposal, a single TCI field may be included in the DCI format. Multiple TCI States may be configured per CC or cell. Each TCI State may be configured with a different QCL source in different CCs. Accordingly, in a first option, the UE may use the same TCI State index for each scheduled cell. In a second option, the UE may use the same QCL source for each scheduled cell, with the QCL source configured in the TCI State indicated by the TCI State index in the TCI field for one of the scheduled cells. The scheduled cell that is used to determine the QCL source for all the scheduled cells may either be specified, e.g., specified in the 3GPP specification as the scheduled cell with the smallest cell ID, or configured/indicated by the network (e.g., by a serving base station) via RRC/MAC-CE/DCI.

According to a third proposal, the network may configure the mapping of TCI codepoint (or the mapping of the value of the TCI field) to the TCI State for each scheduled cell, as illustrated for example in the table in FIG. 11, for a single DCI used for configuring physical data channel(s) for the UE on three (3) different cells.

According to a fourth proposal, the UE may use a default beam for each carrier, when the offset between the DCI and a corresponding (scheduled) PDSCH is smaller than a specified threshold value. The default beam may be defined by one of:
The TCI State of the CORESET with the lowest ID in the last DCI monitoring slot;
The TCI State of the CORESET with the lowest ID; or.
The active TCI of the PDSCH on each carrier with the lowest ID.

A fifth proposal may apply when either multiple TCI fields are used or a single TCI field is used. According to the fifth proposal, in case the multiple beams configured for the UE exceed the UE capability, e.g., the UE cannot receive simultaneously on the configured multiple beams, the UE may either use the beam for the scheduled cell with the lowest ID, or the UE may determine which beam to use according to a specific UE-based implementation (e.g., the individual implementation of the UE may determine which beam the UE is to use in such a scenario.)

### Antenna Ports

According to a first proposal, a fixed solution may be devised to handle configuration of the antenna ports. In a first option, multiple “Antenna Ports” fields may be included in the DCI format, each “Antenna Port” field separately corresponding to a respective scheduled cell. In a second option, a single “Antenna Ports” field may be introduced in the DCI format, with the UE scheduled with the same port configurations on all CCs. If the antenna ports bit width (the number of bits used to indicate the antenna ports) is different for each PDSCH, for example due to mapping Type A or Type B, bit padding and/or bit truncation may be used at the MSB.

According to a second proposal, a single antenna port configuration may be signaled, with each CDM (code division multiplexing) group used for mapping to a different (corresponding) scheduled cell/CC. For example, with a maximum of three (3) CDM groups, the following mapping may be established:
Antenna ports in the first CDM group may correspond to the PDSCH of the first scheduled cell;
Antenna ports in the second CDM group may correspond to the PDSCH of the second scheduled cell; and
Antenna ports in the third CDM group may correspond to the PDSCH of the third scheduled cell.

### Modulation and Coding Scheme/New Data Indicator/Redundancy Version Indication

According to a first proposal, a fixed solution to handle transport block (TB) configuration may be devised. In a first option, multiple MCS/NDI/RV fields may be included in the DCI format, each MCS/NDI/RV field separately corresponding to a respective different scheduled cell. E.g., the MCS/NDI/RV of the PDSCH on each scheduled cell may be independently indicated. In a second option, a single MCS/NDI/RV field may be included in the DCI format, with the UE scheduled with the same TB configuration on all scheduled CCs (or on all scheduled cells.)

According to a second proposal, when a single DCI is used to schedule PDSCH of multiple (e.g., two) cells, respective MCS/NDI/RV values may be used for corresponding codewords for corresponding PDSCHs from different carriers/cells. For example, when using a single DCI to schedule PDSCH on two cells, the MCS/NDI/RV for the first codeword may correspond to the PDSCH on the first cell and the MCS/NDI/RV for the second codeword may correspond to the PDSCH on the second cell. It should be noted that the 3GPP specification allows scheduling up to two codewords (because of MIMO operation of more than 4 layers), and each codeword may have its own corresponding MCS/NDI/RV indication. Accordingly, when only scheduling two cells and each cell only requires one codeword, there is no need for any additional MCS/NDI/RV indications.

According to a third proposal, a differential MCS may be used, for example when the respective channel qualities of different cells are not highly correlated. In this case, a reference MCS and a differential MCS may be signaled. In some embodiments, the reference MCS may be the MCS for the PDSCH of one of the cells. In some embodiments, the differential MCS may apply to the PDSCH of the other cells and may have a different (for example narrower) bit width than the reference MCS. In addition, the reference MCS may be used for the scheduled cell with the smallest serving cell index.

### Use of Single DCI to Schedule Physical Data Channel(s) on Multiple Cells

When using a single DCI to schedule physical data channel(s) on multiple cells or component carriers, implementing a single DCI field versus multiple DCI fields for the relevant communication parameters may be based on the desired tradeoff between scheduling flexibility and DCI size reduction. Accordingly, when a single DCI field is used, the same field may be applied to all the scheduled cells for the UE, and when multiple DCI fields are used, a different respective DCI field of the multiple DCI fields may be applied to each respective scheduled cell. Whether a single DCI field or multiple DCI fields are used may be independently determined for each of at least the following fields/communication parameters:
VRB-to-PRB mapping;
PRB bundling size indicator;
Rate matching indicator;
ZP CSI-RS trigger;
HARQ process number;
TPC command for scheduled PUCCH;
PUCCH resource indicator;
PDSCH-to-HARQ_feedback timing indicator;
SRS request;
CBG transmission information (CBGTI), CBG flushing out information (CBGFI);
DMRS sequence initialization;
Priority indicator;
Minimum applicable scheduling offset indicator; and
SCell dormancy indication.

### Exemplary Method of Scheduling Physical Data Channels on Multiple Cells

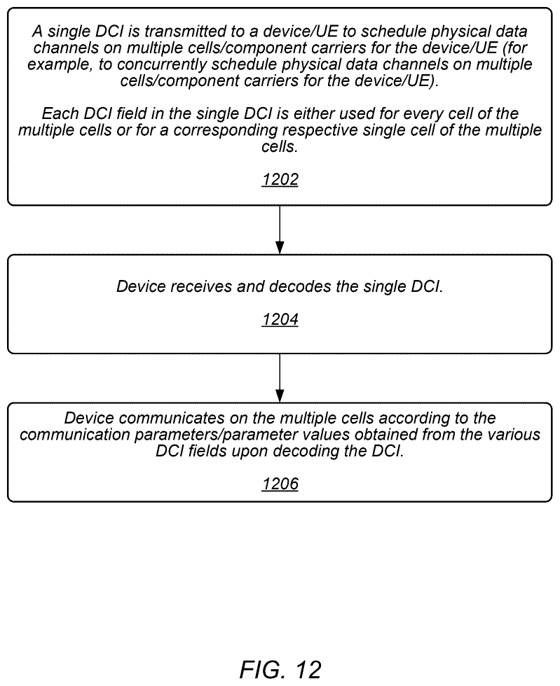

FIG. 12 shows an exemplary flow diagram illustrating a method of scheduling physical data channels on multiple cells or component carriers via a single DCI, according to some embodiments. A single downlink control information (DCI) may be transmitted to a device, e.g., a UE, to schedule physical data channels, e.g., PDSCH and/or PUSCH, on multiple cells/component carriers for the device/UE (1202). In some embodiments, the single DCI may concurrently schedule the physical data channels on the multiple cells/component carriers for the device/UE. Each DCI field in the single DCI may either be used for every cell of the multiple cells or for a corresponding respective single cell of the multiple cells. The device may receive and decode the single DCI (1204), and may subsequently communicate on the multiple cells according to the communication parameters/parameter values obtained from the various DCI fields upon decoding the DCI (1206).

### Various Embodiments of Scheduling Physical Data Channels for a UE on Multiple Cells/Component Carriers Via a Single DCI

Some embodiments may include a method for scheduling physical data channels on multiple cells, the method including: transmitting, to a device, single downlink control information (DCI) that schedules physical data channels on multiple cells for the device, where the single DCI includes one or more DCI fields, and each DCI field of at least a subset of the one or more DCI fields is either used for every cell of the multiple cells or a corresponding single cell of the multiple cells.

The one or more DCI fields may include one or more of: a virtual resource block (VRB) to physical resource block (PRB) mapping field, a PRB bundling size indicator field, a rate matching indicator field, a zero power (ZP) channel state information reference signal (CSI-RS) trigger field, a hybrid automatic repeat request (HARQ) process number field, a transmit power control (TPC) command for scheduled physical uplink control channel (PUCCH) field, a PUCCH resource indicator field, a physical downlink shared channel (PDSCH)-to-HARQ feedback timing indicator field, a sounding reference signal (SRS) request field, a code block group (CBG) transmission information (CBGTI) field, a CBG flushing out information (CBGFI) field, a demodulation reference signal (DMRS) sequence initialization field, a priority indicator field, a minimum applicable scheduling offset indicator field, or a secondary cell (SCell) dormancy indication field.

In some embodiments, the single DCI is defined based on a multi-carrier radio network temporary identifier defined to scramble a cyclic redundancy check (CRC) of the single DCI.

In some embodiments, the single DCI has a special format in which each DCI field of the one or more DCI fields is designed to indicate scheduling of information for multiple scheduled cells.

In some embodiments, the single DCI is a result of a concatenation of individual DCIs, each individual DCI corresponding to a different cell of the multiple cells.

In some embodiments, the one or more DCI fields include multiple carrier indicator (CI) fields, where each CI field corresponds to a different single cell of the multiple cells.

In some embodiments, the one or more DCI fields include a single carrier indicator (CI) field that corresponds to every cell of the multiple cells.

In some embodiments, a mapping of the single CI field to the multiple cells is configured by a serving base station serving the device.

In some embodiments, the mapping is configured by the serving base station via radio resource control (RRC).

In some embodiments, the mapping is updated via a media access control (MAC) control element (CE).

In some embodiments, a mapping of the single CI field to the multiple cells is predetermined for each scheduled cell of the multiple cells.

In some embodiments, the one or more DCI fields include multiple bandwidth part (BWP) indicator (BWPI) fields, where each BWPI field corresponds to a different single cell of the multiple cells.

In some embodiments, the one or more DCI fields include a single bandwidth part (BWP) indicator (BWPI) field that corresponds to every cell of the multiple cells.

In some embodiments, the method further includes: switching, by the device, to a BWP indicated by the BWPI field on every cell of the multiple cells.

In some embodiments, the method further includes: switching, by the device, to a BWP indicated by the BWPI field on only a single cell of the multiple cells.

In some embodiments, the one or more DCI fields include a single bandwidth part (BWP) indicator (BWPI) field that is mapped to multiple BWPs.

In some embodiments, a mapping between the BWPI field and a BWP in each cell of the multiple cells is either predetermined or configured by a serving base station via radio resource control (RRC).

In some embodiments, a same frequency domain resource allocation type is configured for every cell of the multiple cells.

In some embodiments, a different frequency domain resource allocation type is configured for each cell of the multiple cells.

In some embodiments, the one or more DCI fields include multiple frequency domain resource assignment (FDRA) fields, where each FDRA field corresponds to a different single cell of the multiple cells.

In some embodiments, the one or more DCI fields include a single frequency domain resource assignment (FDRA) field that corresponds to every cell of the multiple cells.

In some embodiments, a size of a first active bandwidth part (BWP) indicated by the FDRA field for a first cell of the multiple cells is different from a size of a second active BWP indicated by the FDRA field for a second cell of the multiple cells.

In some embodiments, when indicating the FDRA in the second BWP requires fewer bits than indicating the FDRA in the first BWP, one or more most significant bits of the FDRA field are discarded, and where when indicating the FBRA in the second BWP requires more bits than indicating the FDRA in the first BWP, one or more zero bits are appended to the most significant bit.

In some embodiments, the one or more DCI fields include multiple time domain resource allocation (TDRA) fields, where each TDRA field corresponds to a different single cell of the multiple cells.

In some embodiments, the one or more DCI fields include a single time domain resource allocation (TDRA) field that corresponds to every cell of the multiple cells.

In some embodiments, the TDRA field indicates a same TDRA for every cell of the multiple cells.

In some embodiments, the TDRA field indicates a first TDRA for a first cell of the multiple cells, and where a second TDRA for a second cell of the multiple cells is derived from the first TDRA.

In some embodiments, derivation of the second TDRA from the first TDRA is configured via radio resource control (RRC).

In some embodiments, the second TDRA is derived via an offset of starting symbols.

In some embodiments, one or more of the following are the same for every cell of the multiple cells: mapping types; or a duration of a scheduled physical data channel.

In some embodiments, a corresponding TDRA value for each cell of the multiple cells is obtained from a TDRA table indexed by a value indicated in the single TDRA field.

In some embodiments, the one or more DCI fields include multiple transmission configuration indication (TCI) fields, where each TCI field corresponds to a different single cell of the multiple cells.

In some embodiments, the one or more DCI fields include a single transmission configuration indication (TCI) field that corresponds to every cell of the multiple cells.

In some embodiments, for every cell of the multiple cells the device uses one of: a TCI State index indicated by the TCI field; or a quasi-co-location (QCL) source configured in a TCI state indicated by the TCI State index in the TCI field for a given cell of the multiple cells.

In some embodiments, the given cell is determined according to one of: a specified attribute of the given cell; or an indication received by the device from a serving base station.

In some embodiments, a corresponding TCI state for each cell of the multiple cells is obtained from a TCI table indexed by a value indicated in the single TCI field.

In some embodiments, the device uses a default beam for each cell of the multiple cells when an offset between the single DCI and a corresponding scheduled physical data channel is smaller than a specified threshold value.

In some embodiments, the default beam is defined by one of: a TCI state of a control resource set (CORESET) with a lowest identifier (ID) in a last DCI monitoring slot; a TCI State of a CORESET with a lowest ID; or an active TCI of the corresponding scheduled physical data channel on each cell with a lowest ID.

In some embodiments, when the device cannot simultaneously receive on multiple beams configured for the device, the device uses one of: a beam scheduled for a cell of the multiple cells with a lowest identifier; or a beam determined by the device.

In some embodiments, the one or more DCI fields include multiple antenna ports (AP) fields, where each AP field corresponds to a different single cell of the multiple cells.

In some embodiments, the one or more DCI fields include a single antenna ports (AP) field that corresponds to every cell of the multiple cells.

In some embodiments, the device is scheduled with a same port configuration on every cell of the multiple cells.

In some embodiments, when a number of bits used to indicate the AP for one scheduled physical data channel differs from the number of bits used to indicate the AP for another scheduled physical data channel, one or more most significant bits in the AP field are either padded or truncated.

In some embodiments, the single AP field indicates a single AP configuration, and where a different code division multiplexing group is used for mapping to each different cell of the multiple cells.

In some embodiments, the one or more DCI fields include multiple coding and modulation scheme/new data indicator/redundancy version (MCS/NDI/RV) fields, where each MCS/NDI/RV field corresponds to a different single cell of the multiple cells.

In some embodiments, the one or more DCI fields include a single coding and modulation scheme/new data indicator/redundancy version (MCS/NDI/RV) field that corresponds to every cell of the multiple cells.

In some embodiments, the device is scheduled with a same transport block (TB) configuration on every cell of the multiple cells.

In some embodiments, an MCS/NDI/RV for a first codeword corresponds to a scheduled first physical data channel on a first cell of the multiple cells, and an MCS/NDI/RV for a second codeword corresponds to a scheduled second physical data channel on a second cell of the multiple cells.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for scheduling physical data channels on multiple cells, the method comprising:
transmitting, to a device, single downlink control information (DCI) that schedules physical data channels on multiple cells for the device, wherein the single DCI includes one or more DCI fields, wherein each DCI field of at least a subset of the one or more DCI fields is either used for:
every cell of the multiple cells, or
a corresponding single cell of the multiple cells.

2. The method of claim 1, wherein the one or more DCI fields include one or more of:
a virtual resource block (VRB) to physical resource block (PRB) mapping field,
a PRB bundling size indicator field,
a rate matching indicator field,
a zero power (ZP) channel state information reference signal (CSI-RS) trigger field,
a hybrid automatic repeat request (HARQ) process number field,
a transmit power control (TPC) command for scheduled physical uplink control channel (PUCCH) field,
a PUCCH resource indicator field,
a physical downlink shared channel (PDSCH)-to-HARQ feedback timing indicator field,
a sounding reference signal (SRS) request field,
a code block group (CBG) transmission information (CBGTI) field,
a CBG flushing out information (CBGFI) field,
a demodulation reference signal (DMRS) sequence initialization field,
a priority indicator field,
a minimum applicable scheduling offset indicator field, or
a secondary cell (SCell) dormancy indication field.

3. The method of claim 1, wherein the single DCI is defined based on a multi-carrier radio network temporary identifier defined to scramble a cyclic redundancy check (CRC) of the single DCI.

4. The method of claim 1, wherein the single DCI has a special format in which each DCI field of the one or more DCI fields is designed to indicate scheduling of information for multiple scheduled cells.

5. The method of claim 1, wherein the single DCI is a result of a concatenation of individual DCIs, each individual DCI corresponding to a different cell of the multiple cells.

6. The method of claim 1, wherein the one or more DCI fields include a single carrier indicator (CI) field that corresponds to every cell of the multiple cells, wherein a mapping of the single CI field to the multiple cells is configured by a serving base station serving the device.

7. The method of claim 1, wherein the one or more DCI fields include a single bandwidth part (BWP) indicator (BWPI) field that corresponds to every cell of the multiple cells, wherein the method further comprises switching, by the device, to either:
a BWP indicated by the BWPI field on every cell of the multiple cells; or
a BWP indicated by the BWPI field on only a single cell of the multiple cells.

8. The method of claim 1, wherein the single DCI configures either a same frequency domain resource allocation type for every cell of the multiple cells or a different frequency domain resource allocation type for each cell of the multiple cells.

9. The method of claim 1, wherein the one or more DCI fields include a single frequency domain resource assignment (FDRA) field that corresponds to every cell of the multiple cells, wherein a size of a first active bandwidth part (BWP) indicated by the FDRA field for a first cell of the multiple cells is different from a size of a second active BWP indicated by the FDRA field for a second cell of the multiple cells.

10. The method of claim 9, wherein when indicating the FDRA in the second BWP requires fewer bits than indicating the FDRA in the first BWP, one or more most significant bits of the FDRA field are discarded, and wherein when indicating the FBRA in the second BWP requires more bits than indicating the FDRA in the first BWP, one or more zero bits are appended to the most significant bit.

11. The method of claim 1, wherein the one or more DCI fields include a single time domain resource allocation (TDRA) field that corresponds to every cell of the multiple cells, wherein the TDRA field indicates either:
a same TDRA for every cell of the multiple cells; or
a first TDRA for a first cell of the multiple cells, with a second TDRA for a second cell of the multiple cells derived from the first TDRA.

12. The method of claim 1, wherein the one or more DCI fields include a single time domain resource allocation (TDRA) field that corresponds to every cell of the multiple cells, wherein a corresponding TDRA value for each cell of the multiple cells is obtained from a TDRA table indexed by a value indicated in the single TDRA field.

13. The method of claim 1, wherein the one or more DCI fields include a single transmission configuration indication (TCI) field that corresponds to every cell of the multiple cells, wherein for every cell of the multiple cells the device uses one of:
a TCI State index indicated by the TCI field; or
a quasi-co-location (QCL) source configured in a TCI state indicated by the TCI State index in the TCI field for a given cell of the multiple cells.

14. The method of claim 13, wherein the given cell is determined according to one of:
a specified attribute of the given cell; or
an indication received by the device from a serving base station.

15. The method of claim 1, wherein the one or more DCI fields include a single transmission configuration indication (TCI) field that corresponds to every cell of the multiple cells, wherein a corresponding TCI state for each cell of the multiple cells is obtained from a TCI table indexed by a value indicated in the single TCI field.

16. The method of claim 1, wherein the one or more DCI fields include a single antenna ports (AP) field that corresponds to every cell of the multiple cells, wherein when a number of bits used to indicate the AP for one scheduled physical data channel differs from the number of bits used to indicate the AP for another scheduled physical data channel, one or more most significant bits in the AP field are either padded or truncated.

17. The method of claim 1, wherein the one or more DCI fields include a single coding and modulation scheme/new data indicator/redundancy version (MCS/NDI/RV) field that corresponds to every cell of the multiple cells, wherein the device is scheduled with a same transport block (TB) configuration on every cell of the multiple cells.

18. The method of claim 1, wherein the one or more DCI fields include a single coding and modulation scheme/new data indicator/redundancy version (MCS/NDI/RV) field that corresponds to every cell of the multiple cells, wherein an MCS/NDI/RV for a first codeword corresponds to a scheduled first physical data channel on a first cell of the multiple cells, and wherein an MCS/NDI/RV for a second codeword corresponds to a scheduled second physical data channel on a second cell of the multiple cells.

19. An apparatus configured to cause a base station to:
transmit, to a device, single downlink control information (DCI) that schedules physical data channels on multiple cells for the device, wherein the single DCI includes one or more DCI fields, wherein each DCI field of at least a subset of the one or more DCI fields is either used for:
every cell of the multiple cells, or
a corresponding single cell of the multiple cells.

20. An apparatus configured to cause a device to:
receive, from a base station, single downlink control information (DCI) that schedules physical data channels on multiple cells for the device, wherein the single DCI includes one or more DCI fields, wherein each DCI field of at least a subset of the one or more DCI fields is either used for:
every cell of the multiple cells, or
a corresponding single cell of the multiple cells.
